(19) United States
(12) Patent Application Publication
(10) Pub. No.: US 2024/0332570 A1
(43) Pub. Date: Oct. 3, 2024

(54) ALKALINE NEGATIVE ELECTROLYTE AND ALKALINE ZINC-IRON FLOW BATTERY ASSEMBLED BY SAME

(71) Applicant: DALIAN INSTITUTE OF CHEMICAL PHYSICS, CHINESE ACADEMY OF SCIENCES, Dalian (CN)

(72) Inventors: Xianfeng LI, Dalian (CN); Pengcheng XU, Dalian (CN); Zhizhang YUAN, Dalian (CN)

(73) Assignee: DALIAN INSTITUTE OF CHEMICAL PHYSICS, CHINESE ACADEMY OF SCIENCES, Dalian (CN)

(21) Appl. No.: 18/709,518

(22) PCT Filed: Sep. 20, 2022
(86) PCT No.: PCT/CN2022/119948

§ 371 Date: May 13, 2024

(30) Foreign Application Priority Data
Nov. 11, 2021 (CN) 202111333382.6

(51) Int. Cl. H01M 8/04186; H01M 8/18

(52) U.S. Cl. CPC H01M 8/04186; H01M 8/188

(57) ABSTRACT

An alkaline negative electrolyte and alkaline zinc-iron flow battery assembled by same are provided. The alkaline negative electrolyte includes zinc ions, a complexing agent, and alkali; the complexing agent is at least one selected from the group consisting of ethylenediaminetetraacetic acid, ethylene glycol diethyl ether diamine tetraacetic acid, cyclohexane tetraacetic acid, and ethylenediamine tetrapropionic acid; a molar ratio of the zinc ions to the complexing agent is 1:1; and a molar ratio of the complexing agent to the alkali is 1:(3-4). The zinc ions in the negative electrolyte are in form of a complex state, which is used as the negative electrolyte to assemble and obtain the alkaline zinc-iron flow battery, solves the problem of electrolyte migration in alkaline zinc-iron flow battery and improves the cycling stability of the battery; moreover, it improves the low-temperature performance of the battery, and broadens the operating temperature range of alkaline zinc-iron flow battery.

### CROSS REFERENCE TO THE RELATED APPLICATIONS

This application is the national phase entry of International Application No. PCT/CN2022/119948, filed on Sep. 20, 2022, which is based upon and claims priority to Chinese Patent Application No. 202111333382.6, filed on Nov. 11, 2021, the entire contents of which are incorporated herein by reference.

### TECHNICAL FIELD

The present application relates to alkaline negative electrolyte and alkaline zinc-iron flow battery assembled by same, which belongs to the field of flow battery.

### BACKGROUND

With the increasing depletion of fossil energy sources, the development and utilization of renewable energy sources such as wind energy and solar energy have become the focus of attention in various countries. As the discontinuity and instability of wind and solar energy caused by the effects of weather and other factors, it will cause an impact on the power grid during the grid connection process of renewable energy generation, which will affect the quality of power supply and grid stability. Energy storage technology can solve this problem and ensure the efficient and stable operation of renewable energy power generation grid connection. Energy storage technology is mainly divided into two categories: physical energy storage and chemical energy storage. Chemical energy storage, represented by flow batteries, has the most advantages in large-scale energy storage due to its independent power and capacity, rapid response, simple structure, easy to design, long cycle life, environmental friendliness, and many other advantages. Alkaline zinc-iron flow batteries use resource rich zinc and iron as active materials, are characterized by low cost (˜$100/kWh) and high open-circuit voltage (1.74 V), and has a good application prospect in the field of energy storage, especially in the field of distributed energy storage. However, under the combined effect of electric field gradient and concentration gradient on the electrolyte of alkaline zinc-iron flow batteries, the bound water carried by charge-balancing ions migrates from the negative electrode to the positive electrode of the batteries, causing an imbalance in the volume of the electrolyte, which lead to poor cycling stability of the batteries. Zinc generated by charging at the negative electrode of alkaline zinc-iron flow batteries is easy to fall off, which affects the Coulombic efficiency and cycling performance of the batteries. In addition, the solubility of positive active material in the electrolyte of alkaline zinc-iron flow batteries is greatly affected by temperature, and the positive active material is easy to precipitate in the low-temperature operation of the batteries, which leads to battery failure.

### SUMMARY

According to a first aspect of the present application, there is provided an alkaline negative electrolyte. The alkaline negative electrolyte adopts a complex form of zinc ions to solve the electrolyte migration problem in alkaline zinc-iron flow batteries, which improve battery cycling stability; simultaneously improve the low-temperature performance of the battery and broaden the operating temperature range of alkaline zinc-iron flow batteries.

An alkaline negative electrolyte, where the negative electrolyte comprises zinc ions, a complexing agent, and alkali;
the complexing agent is at least one selected from the group consisting of ethylenediaminetetraacetic acid, ethylene glycol diethyl ether diamine tetraacetic acid, cyclohexane tetraacetic acid, and ethylenediamine tetrapropionic acid;
a molar ratio of the zinc ions to the complexing agent is 1:1;
and a molar ratio of the complexing agent to the alkali is 1:(3-4).

Optionally, the molar ratio of the complexing agent to the alkali is independently selected from any value or a range value determined by any two of 1:3, 1:3.1, 1:3.2, 1:3.3, 1:3.4, 1:3.5, 1:3.6, 1:3.7, 1:3.8, 1:3.9, 1:4.

Optionally, the complexing agent is ethylenediaminetetraacetic acid.

Optionally, the concentration of the zinc ions is from 0.1 mol·L⁻¹ to 2 mol·L⁻¹.

Optionally, the concentration of the zinc ions is from 0.2 mol·L⁻¹ to 1 mol·L⁻¹.

Optionally, the concentration of the zinc ions is independently selected from any value or a range value determined by any two of 0.1 mol·L⁻¹, 0.2 mol·L⁻¹, 0.3 mol·L⁻¹, 0.4 mol·L⁻¹, 0.5 mol·L⁻¹, 0.6 mol·L⁻¹, 0.7 mol·L⁻¹, 0.8 mol·L⁻¹, 0.9 mol·L⁻¹, 1.0 mol·L⁻¹, 1.1 mol. L⁻¹, 1.2 mol·L⁻¹, 1.3 mol·L⁻¹, 1.4 mol·L⁻¹, 1.5 mol·L⁻¹, 1.6 mol. L⁻¹, 1.7 mol·L⁻¹, 1.8 mol·L⁻¹, 1.9 mol. L⁻¹, 2.0 mol·L⁻¹.

According to a second aspect of the present application, there is provided a method of preparing the alkaline negative electrolyte.

The method of preparing the alkaline negative electrolyte described above comprises the following steps:
dissolving the alkali, and adding complexing agent, followed by a zinc salt; when completely dissolved, adjusting pH to 9-13.

Optionally, the zinc salt is at least one selected from the group consisting of zinc sulfate, zinc bromide, zinc chloride, zinc nitrate, zinc acetate, zinc trifluoromethanesulfonate, zinc bis(trifluoromethylsulfonyl)imide, zinc tetrafluoroborate, zinc hexafluorophosphate, zinc bis(oxalate) borate.

Optionally, the alkali is at least one of NaOH, KOH.

According to a third aspect of the present application, there is provided an alkaline zinc-iron flow battery. The negative electrolyte of alkaline zinc-iron flow battery is the alkaline negative electrolyte mentioned above. By introducing the complexing agent into the negative electrolyte, the zinc ions in the negative electrolyte are in the form of a complexing state, which solves the problem of electrolyte migration in the alkaline zinc-iron flow battery and improves the cycling stability of the battery, and at the same time, the lower limit of the operating temperature of the alkaline zinc-iron flow battery is lowered from room temperature to below 0° C., which broadens the usage range of the alkaline zinc-iron flow battery.

An alkaline zinc-iron flow battery, where it contains a positive electrode, a positive electrolyte, a separator, a negative electrode, and a negative electrolyte;
the negative electrolyte is the negative electrolyte mentioned above.

Optionally, the positive electrolyte comprises Fe(CN)₆⁴⁻, alkali;
the alkali is at least one of NaOH, KOH.

Optionally, a concentration of Fe(CN)₆⁴⁻ in the positive electrolyte is from 0.4 M to 2 M; a concentration of OH in the positive electrolyte is from 0.4 M to 2 M.

Optionally, the concentration of Fe(CN)₆⁴⁻ in the positive electrolyte is from 0.6 M to 1 M; the concentration of OH in the positive electrolyte is from 0.6 M to 1 M.

Optionally, the concentration of Fe(CN)₆⁴⁻ in the positive electrolyte is independently selected from any value or a range value determined by any two of 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, 2.0 M.

Optionally, the concentration of OH in the positive electrolyte is independently selected from any value or a range value determined by any two of 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, 2.0 M.

Optionally, the separator is selected from one of ion-conducting membrane and Nafion membrane;
an electrode material of the positive and the negative electrode is selected from one of graphite felt and carbon felt.

Optionally, the separator is selected from polybenzimidazole ion-conducting membrane or sulfonated polyether ether ketone ion-conducting membrane;
the electrode material of the positive and the negative is selected from carbon felt.
   Beneficial Effects that can be Produced by the Present Application Include:

(1) The alkaline negative electrolyte provided by the present application, which adopts a complex form of zinc ions, solves the problem of electrolyte migration in alkaline zinc-iron flow batteries, and improves the cycling stability of the batteries, and by solving the electrolyte migration, maintains ion balance between the positive and the negative electrode, improves the low-temperature performance of the batteries, and broadens the operating temperature range of alkaline zinc-iron flow batteries.

(2) The present application provides a method of preparing the alkaline negative electrolyte, which does not require a large amount of alkali in the preparation process, is extremely simple to operate, does not generate a large amount of heat in the electrolyte preparation process, and has better safety.

(3) The present application provides an alkaline zinc-iron flow battery, in which the zinc deposition morphology in the negative electrolyte of the battery is denser, and the zinc has a better bond with the deposition substrate and is not easy to fall off, thereby improves the cycling stability of the battery.

### BRIEF DESCRIPTION OF THE DRAWINGS

FIG. 1 is a graph of the cycling performance of the alkaline zinc-iron flow battery of Example 1.

FIG. 2 is the electrolyte of the alkaline zinc-iron flow battery of Example 1 after charging and discharging.

FIG. 3 is the electrolyte of the alkaline zinc-iron flow battery of Comparative Example 1 after charging and discharging.

FIG. 4 is a graph of the cycling performance of the alkaline zinc-iron flow battery of Comparative Example 1.

FIG. 5 is a graph of the cycling performance of the alkaline zinc-iron flow battery of Example 2 under 0° C. conditions.

FIG. 6 shows the cycling performance of the stack with weak alkali system electrolyte.

### DETAILED DESCRIPTION OF THE EMBODIMENTS

The present application will be described in detail below with reference to embodiments, but the present disclosure is not limited to these embodiments.

Unless otherwise specified, the raw materials in the embodiments of the present application were purchased commercially.

The method of analysis in the embodiments of this application is as follows:

Battery performance analysis is performed using the ArbinBT 2000 multifunctional battery test system.

### Example 1

An alkaline zinc-iron flow battery was assembled with sulfonated polyether ether ketone (SPEEK) ion-conducting membrane. The volume of the positive electrolyte was 80 mL; the volume of the negative electrolyte was 80 mL. The composition of the positive electrolyte was: 0.4 mol·L⁻¹ Na₄Fe(CN)₆+0.4 mol·L⁻¹ K₄Fe(CN)₆+0.4 mol·L⁻¹ NaOH+0.4 mol·L⁻¹ KOH; the negative electrolyte was made by first dissolving NaOH and KOH, then adding EDTA, and then adding ZnBr₂, the amounts of EDTA, NaOH, KOH, and ZnBr₂ in the resulting electrolyte were 0.6 mol·L⁻¹, 1.2 mol·L⁻¹, 1.2 mol·L⁻¹, and 0.6 mol·L⁻¹, respectively, and the pH of the electrolyte was adjusted to 12 with 2 mol. L⁻¹ NaOH. The battery was charged to 2V at a current density of 80 mA·cm⁻² and discharged to 0.1 V at a current density of 80 mA·cm⁻². The operating temperature was 25° C.

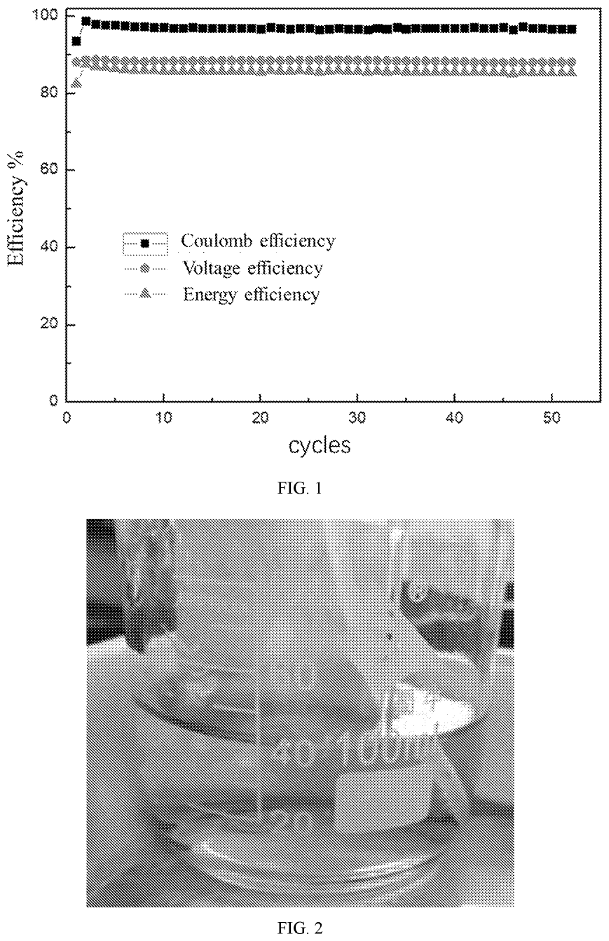

The charging and discharging performance of the battery is stable, and the results are shown in FIG. 1, with a battery CE of 97%, VE of 88%, and EE of 85%. Compared with the traditional alkaline zinc-iron flow battery, the battery CE increased by 3%, which is mainly due to the denser zinc deposition morphology by using this electrolyte, the better bonding of the zinc and the deposition substrate, and no significant zinc falling off (FIG. 2). The battery was operated for 50 cycles, the negative electrolyte migrated 3 mL to the positive electrode, and no obvious electrolyte migration phenomenon appeared. The electrolyte migration problem was solved by using the new electrolyte for the alkaline zinc-iron flow battery, which improved the cycle stability of the battery.

### Comparative Example 1

An alkaline zinc-iron flow battery was assembled with sulfonated polyether ether ketone (SPEEK) ion-conducting membrane. The composition of the positive electrolyte was: 0.4 mol·L⁻¹ Na₄Fe(CN)₆+0.4 mol·L⁻¹ K₄Fe(CN)₆+0.4 mol·L⁻¹ NaOH+0.4 mol·L⁻¹ KOH; the composition of the negative electrolyte was: 0.6 mol·L⁻¹ Na₂Zn(OH)₄+4 mol·L⁻¹ NaOH. The volume of the positive electrolyte was 80 mL; the volume of the negative electrolyte was 80 mL. The battery was charged to 2V at a current density of 80 mA·cm⁻² and discharged to 0.1 V at a current density of 80 mA·cm⁻². The operating temperature was 25° C.

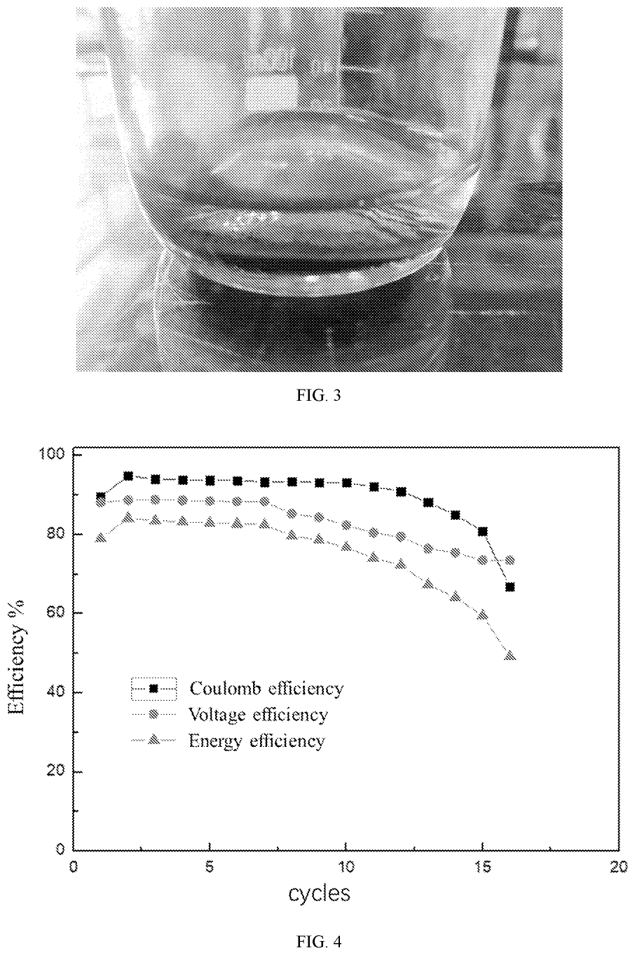

The CE of the battery is 94%, VE is 88%, and EE is 83%, and the CE is 3% lower than that of using the complex electrolyte, which was mainly due to the zinc falling off during battery operation (FIG. 3). The battery run for 10 cycles of charging and discharging, and the negative electrolyte migrated 50 mL to the positive electrode, and the battery performance gradually declined. Compared to the electrolyte in Example 1, the battery cycling stability was poor (as shown in FIG. 4) and electrolyte migration was evident.

### Example 2

An alkaline zinc-iron flow battery was assembled with sulfonated polyether ether ketone (SPEEK) ion-conducting membrane. The composition of the positive electrolyte was: 0.4 mol·L⁻¹ Na₄Fe(CN)₆+0.4 mol·L⁻¹ K₄Fe(CN)₆+0.4 mol·L⁻¹ NaOH+0.4 mol·L⁻¹ KOH; the negative electrolyte was made by first dissolving NaOH and KOH, then adding EDTA, and then adding ZnBr₂, the amounts of EDTA, NaOH, KOH, and ZnBr₂ in the resulting electrolyte were 0.6 mol·L⁻¹, 1.2 mol·L⁻¹, 1.2 mol·L⁻¹, and 0.6 mol·L⁻¹, respectively, and the pH of the electrolyte was adjusted to 12 with 2 mol·L⁻¹ NaOH. The volume of the positive electrolyte was 80 mL; the volume of the negative electrolyte was 80 mL. The battery was charged to 2V at a current density of 80 mA·cm⁻² and discharged to 0.1 V at a current density of 80 mA·cm⁻². The operating temperature was 0° C.

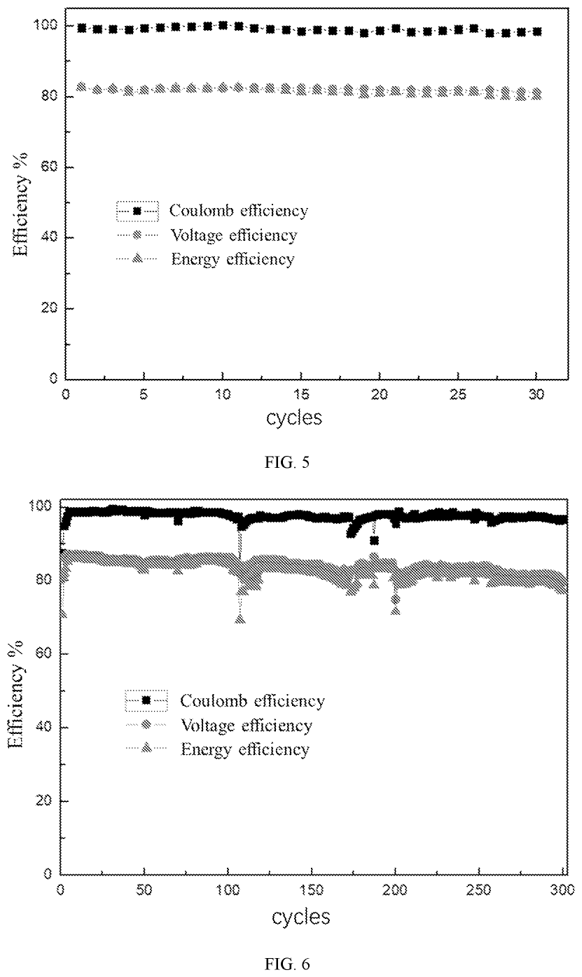

The operation of the alkaline zinc-iron flow battery with the electrolyte is stable (as shown in FIG. 5), and the negative electrolyte migrated only 3 mL to the positive electrode after running the battery for 30 cycles, and no electrolyte precipitation was observed during battery operation. This is mainly due to the improvement of the low-temperature performance of the positive electrolyte by addressing electrolyte migration and maintaining the ion balance between the positive and the negative electrode.

### Comparative Example 2 (Strong Alkali System)

An alkaline zinc-iron flow battery was assembled with sulfonated polyether ether ketone (SPEEK) ion-conducting membrane. The composition of the positive electrolyte was: 0.4 mol·L⁻¹ Na+Fe(CN)₆+0.4 mol·L⁻¹ K₄Fe(CN)₆+0.4 mol·L⁻¹ NaOH+0.4 mol·L⁻¹ KOH; the composition of the negative electrolyte was: 0.6 mol·L⁻¹ Na₂Zn(OH)₄+2 mol·L⁻¹ NaOH. The volume of the positive electrolyte was 80 mL; the volume of the negative electrolyte was 80 mL. The battery was charged to 2V at a current density of 80 mA·cm⁻² and discharged to 0.1 V at a current density of 80 mA·cm⁻². The operating temperature was 0° C.

Electrolyte precipitation occurs during the 1st cycle of battery operation, causing the battery to malfunction.

### Example 3

An alkaline zinc-iron flow battery was assembled with sulfonated polyether ether ketone (SPEEK) ion-conducting membrane. The composition of the positive electrolyte was: 0.4 mol·L⁻¹ Na₄Fe(CN)₆+0.4 mol·L⁻¹ K₄Fe(CN)₆+0.4 mol·L⁻¹ NaOH+0.4 mol·L⁻¹ KOH; the negative electrolyte was made by first dissolving NaOH and KOH, then adding EDTA, and then adding ZnBr₂, the amounts of EDTA, NaOH, KOH, and ZnBr₂ in the resulting electrolyte were 0.6 mol·L⁻¹, 1.2 mol·L⁻¹, 1.2 mol. L⁻¹, and 0.6 mol·L⁻¹, respectively, and the pH of the electrolyte was adjusted to 9, 10, 11, 12, 13, respectively, with 2 mol. L⁻¹ NaOH. The volume of the positive electrolyte was 80 mL; the volume of the negative electrolyte was 80 mL. The battery was charged to 2V at a current density of 80 mA·cm⁻² and discharged to 0.1 V at a current density of 80 mA·cm⁻². The operating temperature was 25° C. The effect of negative electrolyte with different pH on the performance of alkaline zinc-iron flow battery was tested and the results are shown in Table 1.

TABLE 1
The effect of negative electrolyte with different pH
on the performance of alkaline zinc-iron flow battery

| pH | CE/% | VE/% | EE/% |
|---|---|---|---|
| 9 | 97 | 82 | 79 |
| 10 | 97 | 84 | 81 |
| 11 | 97 | 86 | 83 |
| 12 | 97 | 88 | 85 |
| 13 | 97 | 88 | 85 |
| 14 | 94 | 88 | 83 |
| 15 | 90 | 88 | 79 |

As can be seen from the above table, with the increase of pH, the VE and EE of alkaline zinc-iron flow battery gradually increase, when the pH is increased to 12, the VE and EE of the battery remain unchanged, and the pH of the negative electrolyte of the alkaline zinc-iron flow battery is preferably 12. When the pH of the negative electrolyte continues to increase, the CE of the battery gradually decreased, which is mainly due to the fact that as the alkali concentration increases, the zinc deposition morphology gradually changes from dense to loose and porous, resulting in zinc falling off during battery operation.

### Example 4

An alkaline zinc-iron flow battery was assembled with sulfonated polyether ether ketone (SPEEK) ion-conducting membrane. The volume of the positive electrolyte was 80 mL; the volume of the negative electrolyte was 80 mL. The composition of the positive electrolyte was: 0.4 mol·L⁻¹ Na₄Fe(CN)₆+0.4 mol·L⁻¹ K₄Fe(CN)₆+0.4 mol·L⁻¹ NaOH+0.4 mol·L⁻¹ KOH; the negative electrolyte was made by first dissolving NaOH and KOH, then adding a complexing agent, and then adding ZnBr₂, the amounts of the complexing agent, NaOH, KOH, and ZnBr₂ in the resulting electrolyte were calculated at 0.6 mol·L⁻¹, 1.2 mol·L⁻¹, 1.2 mol·L⁻¹, and 0.6 mol·L⁻¹, respectively. The complexing agent is EDTA, EGTA, CyDTA, and EDTP, respectively. And the pH of the electrolyte was adjusted to 12 with 2 mol·L⁻¹ NaOH. The battery was charged to 2V at a current density of 80 mA·cm⁻² and discharged to 0.1 V at a current density of 80 mA·cm⁻². The operating temperature was 25° C.

TABLE 2
The effects of negative electrolyte with different complexing
agents on the performance of alkaline zinc-iron flow battery

| complexing | | | |
|---|---|---|---|
| agents | CE/% | VE/% | EE/% |
| EDTA | 97 | 88 | 85 |
| EGTA | 97 | 84 | 81 |
| CyDTA | 97 | 82 | 80 |
| EDTP | 97 | 78 | 76 |

From the table, it can be seen that the battery has higher VE, EE and optimal battery performance when EDTA is used as the complexing agent.

### Example 5

An alkaline zinc-iron flow battery was assembled with sulfonated polyether ether ketone (SPEEK) ion-conducting membrane. The volume of the positive electrolyte was 80 mL; the volume of the negative electrolyte was 80 mL. The composition of the positive electrolyte was: 0.4 mol·L⁻¹ Na₄Fe(CN)₆+0.4 mol·L⁻¹ K₄Fe(CN)₆+0.4 mol·L⁻¹ NaOH+0.4 mol·L⁻¹ KOH; the negative electrolyte was made by first dissolving NaOH and KOH, then adding EDTA, and then adding a zinc source, the amounts of EDTA, NaOH, KOH, and the zinc source in the resulting electrolyte were calculated at 0.6 mol·L⁻¹, 1.2 mol·L⁻¹, 1.2 mol·L⁻¹, and 0.6 mol·L⁻¹, respectively. The zinc source is zinc sulfate, zinc bromide, zinc chloride, zinc nitrate, zinc acetate, zinc trifluoromethanesulfonate, zinc bis(trifluoromethylsulfonyl)imide, zinc tetrafluoroborate, zinc hexafluorophosphate, zinc bis(oxalate) borate, respectively. And the pH of the electrolyte was adjusted to 12 with 2 mol·L⁻¹ NaOH. The battery was charged to 2V at a current density of 80 mA·cm⁻² and discharged to 0.1 V at a current density of 80 mA·cm⁻². The operating temperature was 25° C.

TABLE 3
The effects of negative electrolytes with different zinc sources
on the performance of alkaline zinc-iron flow battery

| zinc sources | CE/% | VE/% | EE/% |
|---|---|---|---|
| zinc sulfate | 97 | 79 | 77 |
| zinc bromide | 97 | 88 | 85 |
| zinc chloride | 97 | 82 | 80 |
| zinc nitrate | 97 | 77 | 75 |
| zinc acetate | 97 | 75 | 73 |
| zinc trifluoromethanesulfonate | 97 | 74 | 72 |
| zinc | 97 | 70 | 68 |
| bis(trifluoromethylsulfonyl)imide | | | |
| zinc tetrafluoroborate | 97 | 69 | 67 |
| zinc hexafluorophosphate | 97 | 69 | 67 |
| zinc bis (oxalate) borate | 97 | 70 | 68 |

From the table, it can be seen that the battery has higher VE, EE and optimal battery performance when zinc bromide is used as the zinc source.

### Example 6 (a Stack Composed of Multiple Single Cells)

An alkaline zinc-iron flow battery was assembled with polybenzimidazole (PBI) ion-conducting membrane. The composition of the positive electrolyte was: 0.4 mol·L⁻¹ Na₄Fe(CN)₆+0.4 mol·L⁻¹ K₄Fe(CN)₆+0.4 mol·L⁻¹ KOH+0.4 mol·L⁻¹ NaOH; the negative electrolyte was made by first dissolving NaOH and KOH, then adding EDTA, and then adding ZnBr₂, the amounts of EDTA, NaOH, KOH, and ZnBr₂ in the resulting electrolyte were 0.6 mol·L⁻¹, 1.2 mol·L⁻¹, 1.2 mol·L⁻¹, and 0.6 mol·L⁻¹, respectively, and the pH of the electrolyte was adjusted to 12 with 2 mol·L⁻¹ NaOH. Ten 1000 cm² stacks were assembled with a positive electrolyte volume of 60 L, and a negative electrolyte volume of 60 L. The stacks were charged for 2 h at a current density of 40 mA·cm⁻², and then discharged to 8V at a current density of 40 mA·cm⁻² conditioned on voltage cutoff.

It can be seen from FIG. 6 that the initial CE of the stack with weak alkaline system electrolyte is 98.8%, VE is 87.0%, and EE is 86.0% at the areal capacity of 80 mAh/cm², the stacks show excellent cycling performance, and are subjected to 300 cycles with no significant degradation in performance.

### Comparative Example 3

The negative electrolyte: first dissolving NaOH and KOH, then adding EDTA, and then adding ZnBr₂, the amounts of EDTA, NaOH, KOH, and ZnBr₂ in the resulting electrolyte were calculated at 0.4 mol·L⁻¹, 1.2 mol·L⁻¹, 1.2 mol·L⁻¹, and 0.6 mol. L⁻¹, respectively. And the pH of the electrolyte was adjusted to 12 with 2 mol·L⁻¹ NaOH.

The resulting negative electrolyte will have a small amount of precipitation, which is mainly due to that EDTA complexes with zinc ions in a 1:1 ratio, and free zinc ions are produced in the solution when the concentration of the complexing agent is reduced, which reacts with the alkali in the solution to form zinc hydroxide.

### Comparative Example 4

The negative electrolyte: first dissolving NaOH and KOH, then adding EDTA, and then adding ZnBr₂, the amounts of EDTA, NaOH, KOH, and ZnBr₂ in the electrolyte were calculated at 0.6 mol·L⁻¹, 1.2 mol·L⁻¹, 1.2 mol·L⁻¹, and 0.7 mol·L⁻¹, respectively. And the pH of the electrolyte was adjusted to 12 with 2 mol·L⁻¹ NaOH.

The resulting negative electrolyte will have a small amount of precipitation, which is mainly due to that EDTA complexes with zinc ions in a 1:1 ratio, and free zinc ions are produced in the solution when the concentration of the zinc ions is increased, which reacts with the alkali in the solution to form zinc hydroxide.

### COMPARATIVE EXAMPLE

The negative electrolyte: first dissolving NaOH and KOH, then adding ZnBr₂, and then adding EDTA, the amounts of EDTA, NaOH, KOH, and ZnBr₂ in the electrolyte were calculated at 0.6 mol·L⁻¹, 1.2 mol·L⁻¹, 1.2 mol·L⁻¹, and 0.6 mol·L⁻¹, respectively.

According to this preparation method, the zinc ion in the electrolyte reacts with alkali to generate zincate ions, the concentration of the alkali is reduced, and after adding EDTA, due to its slight solubility in water, precipitation will occur. In addition, with this method of formulation, the zinc ions in the electrolyte will be in the form of zincate ions and will no longer be in the form of complexed zinc ions. This is also not conducive to the formation of dense zinc deposits.

The above embodiments are merely some of the embodiments of the present application, and do not limit the present application in any form. Although the present application is disclosed above with the preferred embodiments, the present application is not limited thereto. Some changes or modifications made by any technical personnel familiar with the profession using the technical content disclosed above without departing from the scope of the technical solutions of the present application are equivalent to equivalent implementation cases and fall within the scope of the technical solutions.

What is claimed is:

1. An alkaline negative electrolyte, wherein the alkaline negative electrolyte comprises zinc ions, a complexing agent, and alkali;
the complexing agent is at least one selected from the group consisting of ethylenediaminetetraacetic acid, ethylene glycol diethyl ether diamine tetraacetic acid, cyclohexane tetraacetic acid, and ethylenediamine tetrapropionic acid;
a molar ratio of the zinc ions to the complexing agent is 1:1; and
a molar ratio of the complexing agent to the alkali is 1:(3-4).

2. The alkaline negative electrolyte according to claim 1, wherein a concentration of the zinc ions is from 0.1 mol·L⁻¹ to 2 mol·L⁻¹.

3. The alkaline negative electrolyte according to claim 1, wherein a concentration of the zinc ions is from 0.2 mol·L⁻¹ to 1 mol·L⁻¹.

4. A method of preparing the alkaline negative electrolyte according to claim 1, comprising the following steps:
dissolving the alkali, and adding the complexing agent, followed by a zinc salt; when completely dissolved, adjusting a pH to 9-13.

5. The alkaline negative electrolyte according to claim 1, wherein the zinc salt is at least one selected from the group consisting of zinc sulfate, zinc bromide, zinc chloride, zinc nitrate, zinc acetate, zinc trifluoromethanesulfonate, zinc bis(trifluoromethylsulfonyl)imide, zinc tetrafluoroborate, zinc hexafluorophosphate, and zinc bis(oxalate) borate.

6. The alkaline negative electrolyte according to claim 1, wherein the alkali is at least one of NaOH and KOH.

7. An alkaline zinc-iron flow battery, comprising a positive electrode, a positive electrolyte, a separator, a negative electrode, and a negative electrolyte; wherein
the negative electrolyte is the alkaline negative electrolyte according to claim 1.

8. The alkaline zinc-iron flow battery according to claim 7, wherein the positive electrolyte comprises Fe(CN)₆⁴⁻ and the alkali;
the alkali is at least one of NaOH and KOH.

9. The alkaline zinc-iron flow battery according to claim 8, wherein a concentration of the Fe(CN)₆⁴⁻ in the positive electrolyte is from 0.4 M to 2 M;
a concentration of OH in the positive electrolyte is from 0.4 M to 2 M.

10. The alkaline zinc-iron flow battery according to claim 8, wherein a concentration of the Fe(CN)₆⁴⁻ in the positive electrolyte is from 0.6 M to 1 M;
a concentration of OH in the positive electrolyte is from 0.6 M to 1 M.

11. The alkaline zinc-iron flow battery according to claim 7, wherein the separator is selected from one of an ion-conducting membrane and a Nafion membrane;
an electrode material of the positive electrode and the negative electrode is selected from one of graphite felt and carbon felt.

12. The alkaline zinc-iron flow battery according to claim 7, wherein the separator is selected from a polybenzimidazole ion-conducting membrane or a sulfonated polyether ether ketone ion-conducting membrane.

13. A method of preparing the alkaline negative electrolyte according to claim 2, comprising the following steps:
dissolving the alkali, and adding the complexing agent, followed by a zinc salt; when completely dissolved, adjusting a pH to 9-13.

14. A method of preparing the alkaline negative electrolyte according to claim 3, comprising the following steps:
dissolving the alkali, and adding the complexing agent, followed by a zinc salt; when completely dissolved, adjusting a pH to 9-13.

15. An alkaline zinc-iron flow battery, comprising a positive electrode, a positive electrolyte, a separator, a negative electrode, and a negative electrolyte; wherein
the negative electrolyte is the alkaline negative electrolyte according to claim 2.

16. An alkaline zinc-iron flow battery, comprising a positive electrode, a positive electrolyte, a separator, a negative electrode, and a negative electrolyte; wherein
the negative electrolyte is the alkaline negative electrolyte according to claim 3.

17. The alkaline zinc-iron flow battery according to claim 15, wherein the positive electrolyte comprises Fe(CN)₆⁴⁻ and the alkali;
the alkali is at least one of NaOH and KOH.

18. The alkaline zinc-iron flow battery according to claim 16, wherein the positive electrolyte comprises Fe(CN)₆⁴⁻ and the alkali;
the alkali is at least one of NaOH and KOH.

19. The alkaline zinc-iron flow battery according to claim 17, wherein a concentration of the Fe(CN)₆⁴⁻ in the positive electrolyte is from 0.4 M to 2 M;
a concentration of OH⁻ in the positive electrolyte is from 0.4 M to 2 M.

20. The alkaline zinc-iron flow battery according to claim 18, wherein a concentration of the Fe(CN)₆⁴⁻ in the positive electrolyte is from 0.4 M to 2 M;
a concentration of OH in the positive electrolyte is from 0.4 M to 2 M.
